(19) United States
(12) Patent Application Publication
(10) Pub. No.: US 2006/0069537 A1
(43) Pub. Date: Mar. 30, 2006

(54) Method for simulating noise in an integrated circuit system

(76) Inventor: Lihui Cao, San Jose, CA (US)

Correspondence Address: Sandeep Jaggi;LSI Logic Corporation, Intellectual Property Law Dept., 1621 Barber Lane, M/S D-106, Milpitas, CA, 95035, US

(21) Appl. No.: 10/954,576

(22) Filed: Sep. 29, 2004

(51) Int. Cl. G06F 17/50

(52) U.S. Cl. 703/14

(57) ABSTRACT

The present invention provides a method for simulating noise in an integrated circuit system. According to the method disclosed herein, the present invention includes determining a plurality of peak current values, where each peak current value of the plurality of peak current values corresponds to a different voltage value. The present invention also includes graphing the plurality of peak current values as a function of voltage, and deriving a model based on the graph of the plurality of peak current values. Noise in the integrated circuit system can then be simulated based on the model.

### FIELD OF THE INVENTION

The present invention relates to integrated circuits, and more particularly to a method for simulating noise in an integrated circuit system.

### BACKGROUND OF THE INVENTION

Integrated circuits are well known. Integrated circuits are moving to smaller and smaller feature sizes as process technology advances, and the smaller feature sizes enable integrated circuits to operate at lower voltages and thus consume less power.

A problem, however, with running integrated circuits on lower operating voltages is noise. In particular, instantaneous voltage drops, instantaneous ground bounce, and power noise are an issue in deep sub-micron integrated circuit design. For example, core power noise causes increasing occurrences of clock jitter, gate delay change, timing violation, functional failure, etc. Even though noise amplitude remains relatively low, the effects of noise increases as the core power supply voltage and transistor threshold voltages decrease. In other words, noise margins are reduced.

In a more specific example of the effect of power noise, when a transistor turns on, the supply voltage tends to drop due to inherent inductance and resistance in the circuitry. Conversely, when a transistor turns off, the supply voltage tends to increase. Accordingly, with smaller supply voltage, noise may cause the supply voltage to be insufficient for the transistor to turn on.

Noise can also adversely effect the switching speed of a transistor. For example, a higher supply voltage causes a transistor to switch faster, and a lower supply voltage causes a transistor to switch slower. Accordingly, noise may cause hold-time violations where the transistor switches too fast. Noise may also cause setup-time violations where the transistor switches too slowly.

To ensure the robustness and reliability of an integrated circuit chip, the power noise has to be analyzed, typically using spice tools. Spice tools, which are well known, can model current in a cell or combination of cells. A cell is a unit, which can represent a portion of the integrated circuit. However, for large chips, which have tens of millions of cells, it is not practical to use transistor models (e.g., BISM3) directly in an analysis flow, due to limitations of the spice tool (capacity and speed) and due to additional computer resource requirements.

Accordingly, the analysis must use a simplified model of the cells. Such models also take into account other components in an integrated circuit chip. Components can include, for example, a board, a package, bonding wire, power mesh, etc. Conventionally, a cell or a group of cells is modeled as a “current tap,” where the current is characterized at a certain location in the circuit. This simplifies the analysis and reduces run time and computer resource requirements. The current waveform can be found by running a spice simulation of the cells assuming ideal voltage. Using spice simulation, the current waveform can then be used to simulate potential power noise.

A problem with this conventional method is that the power supply voltage is assumed to be a fixed, ideal value. Consequently, the current value may be over-estimated, since the current value depends on the voltage value. Consequently, if the current value is over-estimated, the simulated noise will be over-estimated. In fact, it is customary to be conservative and accept an over-estimated value. This helps in designing a circuit to be able to handle worst-case scenarios. Being conservative, however, makes it more difficult to take advantage of integrated circuits with smaller feature sizes.

Generally, there is not a good solution to this problem today in that the known solutions are either expensive or unreliable, or they affect performance.

Accordingly, what is needed is an improved method for simulating noise in integrated circuits. The method should be simple, cost effective and capable of being easily adapted to existing technology. The present invention addresses such a need.

### SUMMARY OF THE INVENTION

The present invention provides a method for simulating noise in an integrated circuit system. According to the method disclosed herein, the present invention includes determining a plurality of peak current values, where each peak current value of the plurality of peak current values corresponds to a different voltage value. The present invention also includes graphing the plurality of peak current values as a function of voltage, and deriving a model based on the graph of the plurality of peak current values. Noise in the integrated circuit system can then be simulated based on the model.

### BRIEF DESCRIPTION OF THE DRAWINGS

FIG. 1 is a flow chart showing a method for simulating noise in an integrated circuit in accordance with the present invention.

FIG. 2 is a graph showing peak current as a function of supply voltage in accordance with the present invention.

FIG. 3 shows graphs depicting noise simulation results based on different models.

### DETAILED DESCRIPTION OF THE INVENTION

The present invention relates to integrated circuits, and more particularly to a method for simulating noise in an integrated circuit system. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiment shown, but is to be accorded the widest scope consistent with the principles and features described herein.

The present invention provides a method for simulating noise in an integrated circuit system by deriving a peak current model. This peak current model is then used for noise simulation. The peak current model results in accurate noise simulation, because the current model accounts for various supply voltage values.

Although the present invention disclosed herein is described in the context of power noise and spice algorithms, the present invention may apply to other types of noise and other types of algorithms and still remain within the spirit and scope of the present invention.

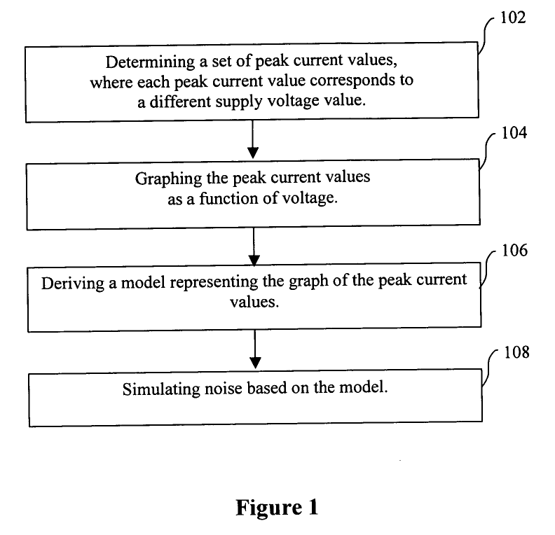

FIG. 1 is a flow chart showing a method for simulating noise in an integrated circuit in accordance with the present invention. First, a set of peak current values is determined, where each peak current value corresponds to a different supply voltage value, in step 102. To determine the peak current values, a spice algorithm is run on cells of an integrated circuit system using different supply voltages. The cells are stored in a cell library. The spice algorithm characterizes a current for each supply voltage value. From this characterization, the spice algorithm provides a set of current values. A peak current value can then be determined from each set of current values.

Next, the peak current values are graphed as a function of supply voltage values, in step 104.

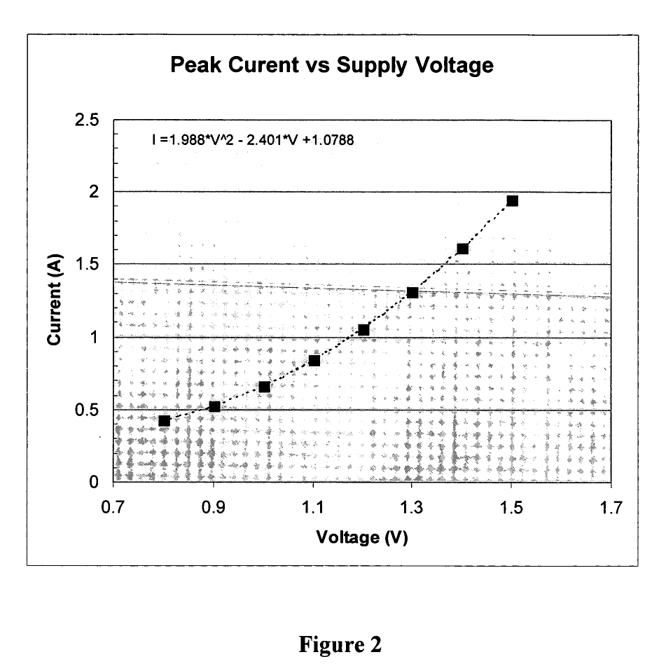

FIG. 2 is a graph showing current as a function of supply voltage in accordance with the present invention. Spice simulation can be used to obtain the data points.

Next, a model representing the graph of the peak current values is derived, in step 106. The model is a mathematical expression derived by fitting data from the graph of step 104 into a polynomial. In a specific embodiment, the polynomial can be second order polynomial. For example, I=aV²+bV+c. Although the polynomial is a second order polynomial, one of ordinary skill in the art will readily realize that other expressions representing the peak current versus supply voltage relationship may be used and still remain within the spirit and scope of the present invention. The model of the present invention is referred to as a voltage-controlled current-source (VCCS) model.

The resulting VCCS model more accurately represents peak current than conventional models, because the VCCS model accounts for various supply voltage values, as opposed to the conventional models where a fixed ideal voltage is assumed.

Next, noise is simulated based on the model, in step 108. In a specific embodiment, the noise being simulated is fast, instantaneous power noise. Also, each current tap for the simulation needs two statements in an Hspice deck. The two lines below are examples and describe a triangle current peak:
Vx1 nx1 0 pulse (0 Ipeak tdelay trise tfall pwd period)
G1 n1 n1vss VCCS POLY(2) n1 n1vss nx 0 0 0 x 0 y 0 0 z

A peak height from the simulation is determined, such that the peak height=B*(x+y*A+z*A*A)*Ipeak; where B=V(nx)−V(0); A=V(n1)−V(n1vss).

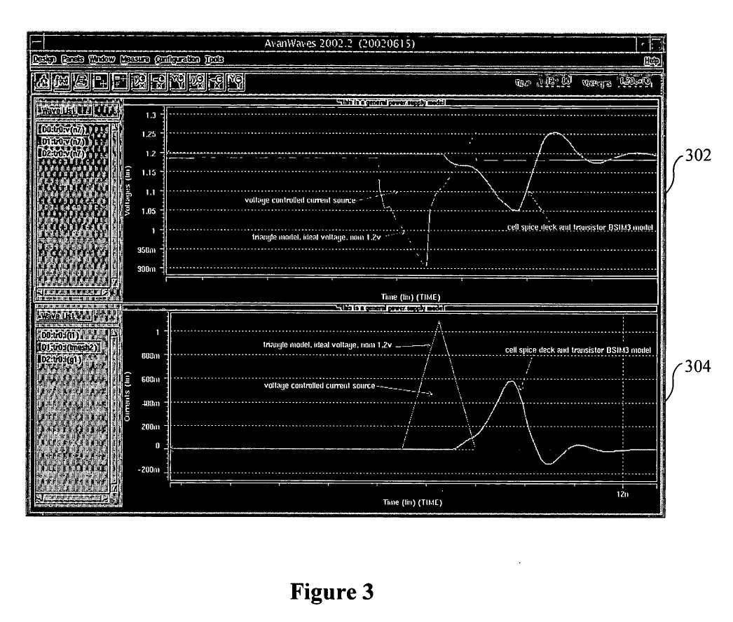

FIG. 3 shows graphs depicting noise simulation results based on different models. The top half 302 shows voltage waveforms, and the bottom half 304 shows current waveforms. As shown, the VCCS model provides accurate results, which are very close results to those from the BSIM3 transistor model. The fixed triangle peak current model over-estimates the peak current.

Alternatively, other types of current models, such as the trapezoidal model and the piece-wise linear model, can also incorporate the present invention as described above, and the corresponding VCCS model can be created and incorporated in the power-noise simulation.

According to the method disclosed herein, the present invention provides numerous benefits. For example, it provides accurate peak current modeling, which results in accurate noise simulation. The method is simple and can be applied to various types of circuits such as application-specific integrated circuits (ASICs).

A method for simulating noise in an integrated circuit system has been disclosed. The present invention has been described in accordance with the embodiments shown. One of ordinary skill in the art will readily recognize that there could be variations to the embodiments, and that any variations would be within the spirit and scope of the present invention. For example, the present invention can be implemented using hardware, software, a computer readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

We claim:

1. A method for simulating noise in an integrated circuit system, the method comprising:
determining a plurality of peak current values, wherein each peak current value of the plurality of peak current values corresponds to a different voltage value;
graphing the plurality of peak current values as a function of voltage; and
deriving a model based on the graph of the plurality of peak current values.

2. The method of claim 1 further comprising simulating noise based on the model.

3. The method of claim 1 wherein the determining step comprises running a spice algorithm on cells of the integrated circuit using a plurality of voltages values.

4. The method of claim 3 wherein the algorithm provides a plurality of current values based on each voltage value, wherein the plurality of peak current values are determined from the plurality of current values.

5. The method of claim 1 wherein the deriving step comprises deriving a mathematical expression by fitting data from the graphing step into a polynomial.

6. The method of claim 5 wherein the polynomial can be a second order polynomial or higher order polynomial.

7. The method of claim 1 wherein the noise being simulated is power and ground noise.

8. The method of claim 1 wherein the simulation can be applied to application-specific integrated circuits (ASICs).

9. A computer readable medium containing program instructions for simulating noise in an integrated circuit system, the program instructions which when executed by a computer system cause the computer system to execute a method comprising:
determining a plurality of peak current values, wherein each peak current value of the plurality of peak current values corresponds to a different voltage value;
graphing the plurality of peak current values as a function of voltage; and
deriving a model based on the graph of the plurality of peak current values.

10. The computer readable medium of claim 1 further comprising program instructions for simulating noise based on the model.

11. The computer readable medium of claim 1 wherein the determining step comprises program instructions for running a spice algorithm on cells of the integrated circuit using a plurality of voltages values.

12. The computer readable medium of claim 11 wherein the algorithm provides a plurality of current values for each voltage value, wherein the plurality of peak current values are determined from the plurality of current values.

13. The computer readable medium of claim 1 wherein the deriving step comprises program instructions for deriving a mathematical expression by fitting data from the graphing step into a polynomial.

14. The computer readable medium of claim 13 wherein the polynomial is a second order polynomial.

15. The computer readable medium of claim 1 wherein the noise being simulated is power noise.

16. The computer readable medium of claim 1 wherein the simulation can be applied to application-specific integrated circuits (ASICs).
